(19) United States
(12) Patent Application Publication
(10) Pub. No.: US 2006/0177136 A1
(43) Pub. Date: Aug. 10, 2006

(54) Automatic input aids in computer programs

(75) Inventor: Helmut Windl, Peisig (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/348,773

(22) Filed: Feb. 7, 2006

(30) Foreign Application Priority Data
Feb. 9, 2005 (EP) 05002710.1

(51) Int. Cl. G09G 5/08; G06F 3/00; G06K 9/00

(52) U.S. Cl. 382/189; 345/157; 715/700

(57) ABSTRACT

The invention relates to a method, a computer program product and a system for providing user information on a screen for input fields which may be edited by a user. In order to make the user information rapidly and easily accessible for the user, the following method steps are proposed: recognition of a cursor positioned within an input field and automatic display of a display window with the user information, immediately after recognition of the cursor positioned within the input field.

### CROSS REFERENCE TO RELATED APPLICATIONS

This application claims priority to the European Application No. 05002710.1, filed Feb. 9, 2005 which is incorporated by reference herein in its entirety.

### FIELD OF INVENTION

The invention relates to a method, a computer program product and a system for providing user information on a screen for input fields which may be edited by a user.

### BACKGROUND OF INVENTION

The invention is used, for example, within software programs where input fields have to be edited by a user and the user requires additional information for correctly completing the fields.

### SUMMARY OF INVENTION

In complex development environments, in particular, specific parameters frequently have to be allocated values via corresponding input fields. For users who use such a development environment only rarely, or merely for the first time, a help function is possibly necessary which provides information to the user about the meaning and purpose of a parameter or its valid value range.

Current software applications therefore generally offer a help system. If required, the user quits the input mask, searches for the required information in the help system and then returns again to the input mask. With faulty input by the user, a dialogue box is generally opened which reports the error and has to be closed by the user, for example, by a mouse click.

An object of the invention is to make user information for editable input fields rapidly and easily accessible for a user within a computer program.

This object is achieved by a method for providing user information on a screen for input fields which may be edited by a user within a computer program, with the following method steps:

recognition of a cursor positioned within an input field and

automatic display of a display window with the user information, immediately after recognition of the cursor positioned within the input field.

This object is further achieved by a computer program product for implementing such a method.

This object is further achieved by a system for providing user information with

a screen for showing input fields which may be edited by a user within a computer program and

a processing unit for recognising a cursor positioned within an input field and for generating a display window with the user information, immediately after recognising the cursor positioned within the input field,

the screen being provided for displaying the display window.

The invention is based on the recognition that, in particular with complex applications, information about an input field should be immediately available for the user when editing. According to the invention, this is ensured by the display window containing this information being opened as soon as the cursor is positioned in the input field. In this case and in the entire text above, any type of input pointer which is standard in the software field is understood by the term cursor. The position of the cursor within the input field clearly signals a desire by the user to assign the input field in any manner. If assistance is required therefor, the user does not have to quit the input mask first in order to start a help function, search for the appropriate information there and then return again to the input mask. Instead, the required information is already directly available in the user interface to be edited by the user, so that the work flow is not interrupted by obtaining the required information.

The disclosed method for providing the information can be used, in particular, in many complex computer applications, where the input field is provided for assigning a parameter with a value and the user is informed by mea ns of the user information about a purpose and/or valid value range of the parameter. For example, when assigning a parameter of a technical system, it is often unclear to a user who is using for the first time, or only seldom uses, the corresponding program, how much influence this parameter has on the technical system and which values are permissible for the parameter. In this embodiment, this information is provided to the user as soon as the desire of the user to assign the value is recognised.

It is often difficult to show all the information which is required for an input field within the display window. In these cases, it is expedient if a hyperlink, which makes further user information accessible to the user, is shown in the display window. Such a hyperlink can refer to documents which are located outside the user interface.

Depending on the complexity of the input field to be assigned, the text which is necessary to show the required user information, can require a very large display window. There is therefore the risk that the display window conceals other input fields within the user interface. Thus it is expedient that the display window is shown independently, when a mouse pointer which may be controlled by the user is positioned within the input field or within an activation region in the display window, in which a function provided by the display window, in particular the hyperlink, may be activated by means of the mouse pointer. However, the display window should be represented as semi-transparent when the mouse pointer is positioned outside the input field and outside the activation region. As long as the mouse pointer is located within the input field, it may be assumed that the user is exclusively occupied with editing the input field. As a result, the user requires no information which is possibly concealed by the display window. As soon as the user moves the mouse pointer into a region outside the input field, the display window is represented as semi-transparent, so that information which is located under the display window is visible to the user. Here, the disclosed semi-transparency of the display window does not only relate to the mode of representation. Furthermore, control buttons which are located underneath the display window, may also be activated by the mouse pointer.

An exception to this is merely where an activation region, for example a control button or a hyperlink, is located within the display window, and to which the user has access with the mouse pointer. In such a case, the display window is represented as opaque as soon as the user moves the mouse pointer into such an activation region. By means of the opaque representation of the display window, it is signalled to the user that it is now possible to activate a function of the display window with the mouse.

In a particularly advantageous embodiment of the invention, during or after faulty editing of the input field, a further display window is displayed which sends an error message. Thus the user is informed at an early stage about an input error. In this connection it is particularly expedient to constrain the cursor to remain in the input field, after the faulty editing of the input field, to correct the faulty editing. As a result, the user is made immediately aware of the faulty input and can only start editing the further input field after having assigned a correct value to the input field.

An advantageous application of the method is characterised in that the computer program is embodied as a development environment, in particular for control tasks in automation technology. During such control tasks, parameters of a technical system frequently have to be assigned with values, a great deal of user knowledge being assumed. In many instances, only a limited permissible value range exists for the corresponding physical parameters. By means of the disclosed method, the user of such a program is informed at an early stage about possible input errors, about a permissible value range of the parameter and about the purpose and the consequences of the physical parameters to be set.

### BRIEF DESCRIPTION OF THE DRAWINGS

The invention is disclosed and described hereinafter in more detail with reference to the embodiments shown in the figures, in which:

FIG. 1 is an input mask with an embodiment of the method for providing user information,

FIG. 2 is an input mask with a further embodiment of the method for providing user information,

FIG. 3 is an input mask with an embodiment of the method for generating an error message and

FIG. 4 is an embodiment of a system for providing user information.

### DETAILED DESCRIPTION OF INVENTION

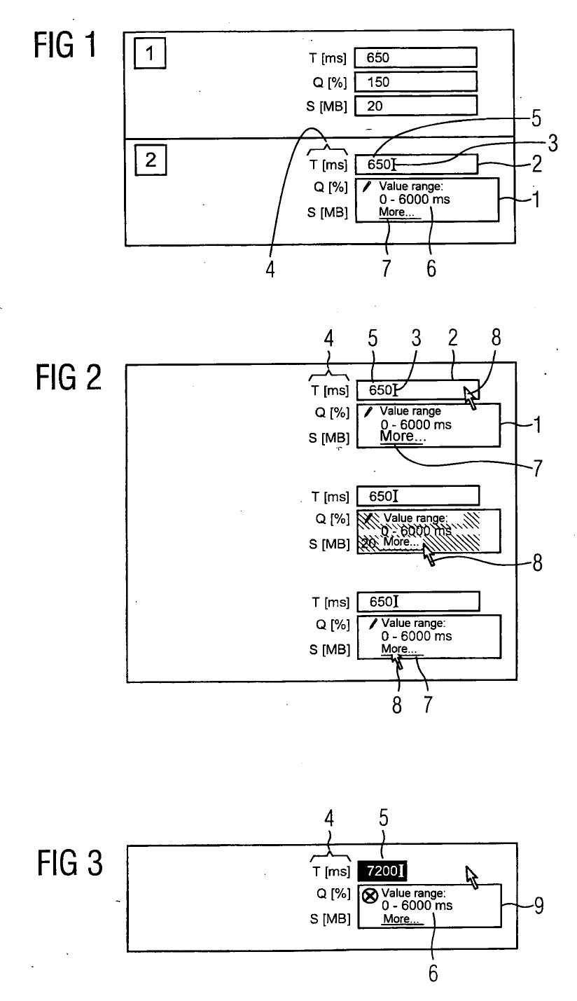

FIG. 1 shows an input mask with an embodiment of the method for providing user information. The input mask is a component of a computer program which, for example, is used in automation technology. The input mask serves to assign a value to predetermined system parameters. To this end, a user moves a mouse pointer into an input field 2. For example, by activating the left mouse button within the input field 2, an input cursor 3 appears in the input field 2. As soon as the cursor 3 is located within the input field 2, a display window 1 is opened, in which information is displayed about the parameter 4 to be assigned. Thus, for example, the valid value range 6 of the variable to be assigned is shown within the display window 1. Furthermore, a hyperlink 7, via which further information about the parameter 4 to be assigned may be accessed, is located within the display window 1. The information linked via the hyperlink 7 is too extensive to be shown within the display window 1.

In the method disclosed, information is provided to the user via the display window 1 about the parameter 4 to be assigned by the user, without the user having to quit the input mask. Thus the workflow of the user is not interrupted by having to call up a help function, within which information is obtained about the parameter 4 to be assigned.

FIG. 2 shows an input mask with a further embodiment of the method for providing user information. It refers, for example, to the same input mask which has already been disclosed in FIG. 1. In this case, also, the user assigns a parameter 4 with a value 5, by moving the mouse pointer 8 into an input field 2, positioning a cursor 3 and activating an appropriate input there. When positioning the cursor 3 within the input field 2 a display window 1 is displayed for showing user information via the parameter 4. As the mouse pointer 8 is located within the input window 2, the display window 1 is represented as opaque, i.e. non-transparent. Input fields which are located underneath the display window 1 are therefore not visible to the user.

When the user moves the mouse pointer 8 into a region outside the input field 2, the display window 1 is represented as semi-transparent. In this manner, input fields which are located underneath the display window 1 are visible to the user and can also be accessed by the mouse pointer 8. Thus the user could now, as shown in the middle of FIG. 2, move the mouse pointer onto a further input field underneath the input field 2, in particular by activating the left mouse button, placing the cursor in this further input field and therefore activating an input within the further input window, in order to assign a value to the corresponding parameter.

A hyperlink 7, which can be activated by the mouse pointer 8, is located within the display window 1, in order to make information accessible to the user. As soon as the user moves the mouse pointer 8 onto the hyperlink 7, the display window 1 is again represented as opaque. The opaque representation of the display window, signals to the user that the hyperlink 7 can be activated by means of the mouse pointer 8, in particular by activating the left mouse button.

The disclosed embodiment of the method allows the user to use the mouse pointer in a quasi-three-dimensional manner. By means of the context-dependent representation of the display window, the user is able both to activate control buttons within the display window 1 and to operate control buttons underneath the display window 1. By means of the semi-transparent representation of the display window 1 the user can see input fields underneath the display window 1 and also assign said input fields with values without firstly having to push the display window 1 awkwardly to one side with the mouse pointer 8.

FIG. 3 shows an input mask with an embodiment of the method when generating an error message. In the example shown, the user assigns a parameter 4 with a value 5 which is located outside a permissible value range 6 of the parameter. Such a faulty input is recognised and communicated to the user by opening a further display window 9. The further input window 9 is opened as soon as the faulty input is recognised. This can occur as early as during input of the value 5 or when the user attempts to quit the input field 2 with the mouse pointer. Moreover, the cursor is constrained to remain within the input field 2 until the user has assigned a permissible value to the parameter 4. In particular when the method is applied within a computer program, with which complex technical equipment, for example an automation device, is controlled, the disclosed treatment of a faulty user input is particularly advantageous. Faulty input, which could possibly result in a critical state of an automation process to be controlled, is immediately prevented during the input of the value 5.

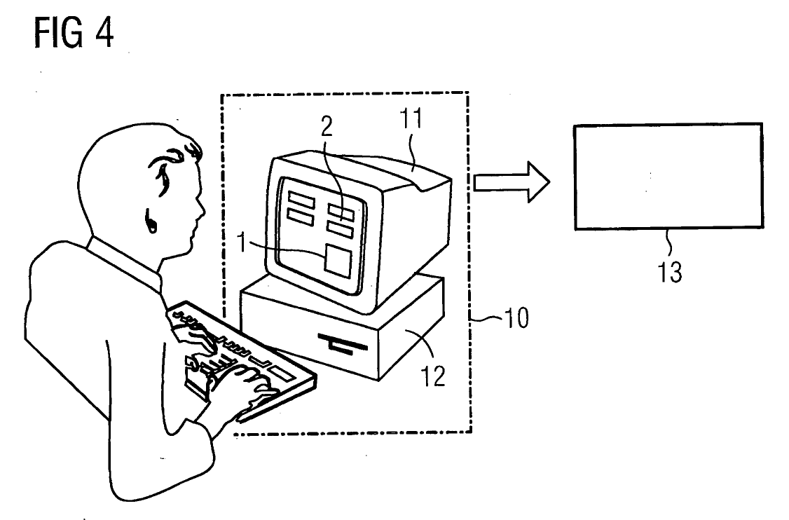

FIG. 4 shows an embodiment of a system 10 for providing user information. The system 10 comprises a screen 11 and a processing unit 12. The system 10 is used for planning a control program for an automation device 13, for example a programmable logic controller (PLC). The control program is firstly planned on the system 10 and then loaded onto the automation device 13.

A computer program product, with which a real time control program can be generated, is installed on the processing unit 12 and which can, for example, be a PC. When creating the control program, a user assigns values to physical parameters via corresponding input fields 2. User information is provided to the user about the parameters to be assigned via a display window 1 in the manner already disclosed. After the user has created and tested the control program on the system 10, the program is loaded onto the automation device 13.

1-17. (canceled)

18. A method for providing user information on a screen for user-editable input fields of a computer program, the method comprising:
detecting a cursor positioned within an input field; and
automatically displaying a display window including the user information immediately after detecting the cursor.

19. The method according to claim 18, wherein the input field is configured to assign a value to a parameter, and the user information includes information on a valid parameter value range or a purpose of the parameter.

20. The method according to claim 18, wherein the user information includes a hyperlink for selectively accessing further information by a user.

21. The method according to claim 18, wherein the display window is represented as opaque when a mouse pointer controlled by the user is positioned within the input field or within an activation region of the display window, the display window providing a function configured to be activated by the mouse pointer.

22. The method according to claim 21, wherein the function is a hyperlink.

23. The method according to claim 18, wherein the display window is represented as semi-transparent when the mouse pointer is positioned outside the input field or outside an activation region of the display window.

24. The method according to claim 18, further comprising displaying an error message by a further display window during or after a faulty editing of the input field.

25. The method according to claim 18, wherein the cursor is constrained to remain in the input field after a faulty editing of the input field for correcting the faulty editing.

26. The method according to claim 18, wherein the computer program is a software development environment.

27. A computer program for providing user information on a screen for user-editable input fields, comprising software modules having software code programmed and configured to:
detect a cursor positioned within an input field; and
automatically display a display window including the user information immediately after detecting the cursor.

28. A system for providing user information, comprising:
a screen for displaying user-editable input fields of a computer program; and
a processing unit for detecting a cursor positioned within an input field and for generating a display window having the user information immediately after detecting the cursor.

29. The system according to claim 28, wherein the input field is configured to assign a value to a parameter, and the user information includes information on a valid parameter value range or a purpose of the parameter.

30. The system according to claim 28, wherein the user information includes a hyperlink for selectively accessing further information by a user.

31. The system according to claim 28, wherein the display window is represented as opaque when a mouse pointer controlled by the user is positioned within the input field or within an activation region of the display window, the display window providing a function configured to be activated by the mouse pointer.

32. The system according to claim 31, wherein the function is a hyperlink.

33. The system according to claim 28, wherein the display window is represented as semi-transparent when the mouse pointer is positioned outside the input field or outside an activation region of the display window.

34. The system according to claim 28, wherein an error message is displayed by a further display window during or after a faulty editing of the input field.

35. The system according to claim 28, wherein the cursor is constrained to remain in the input field after a faulty editing of the input field for correcting the faulty editing.

36. The system according to claim 18, wherein the computer program is a software development environment.
